(19) United States
(12) Patent Application Publication
(10) Pub. No.: US 2011/0232828 A1
(43) Pub. Date: Sep. 29, 2011

(54) METHOD OF FUSER MANUFACTURE

(75) Inventors: Patrick James Finn, Webster, NY (US); David Charles Irving, Avon, NY (US)

(73) Assignee: XEROX CORPORATION, Norwalk, CT (US)

(21) Appl. No.: 12/732,263

(22) Filed: Mar. 26, 2010

(51) Int. Cl. B32B 43/00; B29C 47/06

(52) U.S. Cl. 156/94; 156/244.13

(57) ABSTRACT

There is described a method for producing a fuser member. A substrate is obtained and a fluoropolymer sleeve is positioned around an outer surface of the substrate. An elastomer is injected between the outer surface of the substrate and an inner surface of the sleeve to form a fuser member and demolded. The fuser member is conditioned at a first temperature of between about 30° C. below the melting point of the fluoropolymer and about 50° C. above the melting point of said fluoropolymer for about 1 to about 20 minutes. The fuser member is then optionally held at a second temperature of about 220° C. to about 260° C. for a period of about 4 hours to about 20 hours.

### BACKGROUND

1. Field of Use

This disclosure is generally directed to fuser members useful in electrophotographic imaging apparatuses, including digital, image on image, and the like. This disclosure also relates to processes for making and using fuser members.

2. Background

Generally, in a commercial electrophotographic marking or reproduction apparatus (such as copier/duplicators, printers, multifunctional systems or the like), a latent image charge pattern is formed on a uniformly charged photoconductive or dielectric member. Pigmented marking particles (toner) are attracted to the latent image charge pattern to develop this image on the photoconductive or dielectric member. A receive member, such as paper, is then brought into contact with the dielectric or photoconductive member and an electric field applied to transfer the marking particle developed image to the receiver member from the photoconductive or dielectric member. After transfer, the receiver member bearing the transferred image is transported away from the dielectric member to a fusion station and the image is fixed or fused to the receiver member by heat and/or pressure to form a permanent reproduction thereon. The receiving member passes between a pressure roll and a heated fuser roll or element.

Sometimes copies made in xerographic or electrostatic marking systems have defects caused by incomplete fusing of the marking material or the fuser itself. The incomplete fusing can be the result of many factors such as defects in the toner pressure or fuser rolls. Defects in the fuser rolls can be caused by improper compression set properties resulting from extended use or improper coating of the fuser substrates during manufacture.

### SUMMARY

According to an embodiment, a method for the production of a fuser member is provided. A substrate is obtained and a fluoropolymer sleeve is positioned around an outer surface of the substrate. An elastomer is injected between the outer surface of the substrate and an inner surface of the sleeve to form a fuser member. The fuser member is conditioned at a first temperature of between about 30° C. below the melting point of the fluoropolymer and about 50° C. above the melting point of said fluoropolymer for about 1 to about 20 minutes.

According to an embodiment, there is provided a method for the production of a fuser member. The method includes obtaining a substrate having disposed thereon an elastomer. A fluoropolymer sleeve is positioned over the substrate having the elastomer and the sleeve is heat shrunk to form a fuser member. The fuser member is conditioned at a first temperature of between about 30° C. below the melting point of said fluoropolymer sleeve and about 50° C. above the melting point of said fluoropolymer sleeve for about 1 to about 20 minutes.

According to an embodiment, there is provided a method for reconditioning a fuser member. The method includes obtaining a fuser member having a substrate and elastomeric layer disposed on the substrate and a fluoroplastic sleeve disposed on the elastomeric layer. The fuser member is conditioned at a first temperature of between about 30° C. below the melting point of said fluoropolymer sleeve and about 50° C. above the melting point of said fluoropolymer sleeve for about 1 to about 20 minutes and then heated at a second temperature of about 220° C. to about 260° C. for a period of about 4 hours to about 20 hours.

### BRIEF DESCRIPTION OF THE DRAWINGS

The accompanying drawings, which are incorporated in and constitute a part of this specification, illustrate several embodiments of the present teachings and together with the description, serve to explain the principles of the present teachings.

FIG. 1 is a schematic of an embodiment of a fuser member.

FIG. 2 is a picture of a fuser roller after processing 300,000 images.

FIG. 3 is a picture of a fuser roller treated with an embodiment described herein after processing 300,000 images.

It should be noted that some details of the drawings have been simplified and are drawn to facilitate understanding of the embodiments rather than to maintain strict structural accuracy, detail, and scale.

### DESCRIPTION OF THE EMBODIMENTS

Reference will now be made in detail to embodiments of the present teachings, examples of which are illustrated in the accompanying drawings. Wherever possible, the same reference numbers will be used throughout the drawings to refer to the same or like parts.

In the following description, reference is made to the accompanying drawings that form a part thereof, and in which is shown by way of illustration specific exemplary embodiments in which the present teachings may be practiced. These embodiments are described in sufficient detail to enable those skilled in the art to practice the present teachings and it is to be understood that other embodiments may be utilized and that changes may be made without departing from the scope of the present teachings. The following description is, therefore, merely exemplary.

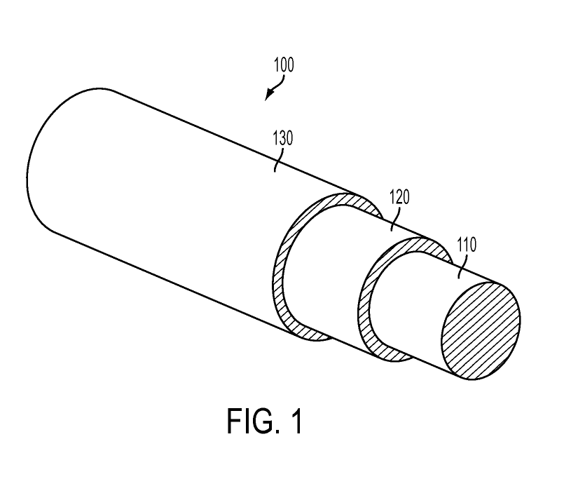

FIG. 1 is a schematic view of an embodiment of a fuser member 100, demonstrating various possible layers. As shown in FIG. 1, a substrate 110 has an intermediate or cushioning layer 120 thereon. Intermediate layer 120 can be, for example, a silicone rubber. On intermediate layer 120 is an outer sleeve 130, for example, a fluoroplastic.

Fuser rolls used in electrophotographic marking systems generally comprise a substrate 110 shown herein as a core cylinder having one or more intermediate layers 120 such as silicone. The intermediate layer 120 can include silicone rubbers such as room temperature vulcanization (RTV) silicone rubbers, high temperature vulcanization (HTV) silicone rubbers, low temperature vulcanization (LTV) silicone rubbers and liquid silicone rubbers (LSR). These rubbers are known and readily available commercially, such as SILASTIC® 735 black RTV and SILASTIC® 732 RTV, both from Dow Corning; and 106 RTV Silicone Rubber and 90 RTV Silicone Rubber, both from General Electric. Other suitable silicone materials include the siloxanes (such as polydimethylsiloxanes); fluorosilicones such as Silicone Rubber 552, available from Sampson Coatings, Richmond, Va.; liquid silicone rubbers such as vinyl crosslinked heat curable rubbers or silanol room temperature crosslinked materials; and the like. Another specific example is Dow Corning Sylgard 182.

Optionally, any known and available suitable adhesive layer may be positioned between the intermediate layer, the outer sleeve and the substrate. Examples of suitable adhesives include silanes such as amino silanes (such as, for example, HV Primer 10 from Dow Corning), titanates, zirconates, aluminates, and the like, and mixtures thereof.

An exemplary embodiment of the outer sleeve 130 include fluoropolymers. These fluoropolymers include fluoropolymers comprising a monomeric repeat unit that is selected from the group consisting of vinylidene fluoride, hexafluoropropylene, tetrafluoroethylene, perfluoroalkylvinylether, and mixtures thereof. The fluoropolymers may include linear or branched polymers, and cross-linked fluoroelastomers. Examples of fluoropolymers include polytetrafluoroethylene (PTFE); perfluoroalkoxy polymer resin (PFA); copolymer of tetrafluoroethylene (TFE) and hexafluoropropylene (HFP); copolymers of hexafluoropropylene (HFP) and vinylidene fluoride (VDF or VF2); copolymers of two of, or terpolymers of tetrafluoroethylene (TFE), vinylidene fluoride (VDF), and hexafluoropropylene (HFP), and mixtures thereof, and tetrapolymers of tetrafluoroethylene (TFE), vinylidene fluoride (VDF), and hexafluoropropylene (HFP) and a cure site monomer. The fluoropolymers provide chemical and thermal stability and have a low surface energy. The fluoropolymer particles have a melting temperature of from about 255° C. to about 360° C. or from about 280° C. to about 330° C. In embodiments, these fluoropolymer sleeves contain at least 70 volume percent fluoropolymers, depending on electrical conductivity, wear and release requirements.

In some embodiments, the intermediate layer includes silicone. Alternatively, the intermediate layer may comprise components other than silicone. In embodiments, the intermediate layer contains at least about 30 volume percent, or at least about 50 volume percent silicone, or at least 70 volume percent silicone, depending on thermal conductivity requirements.

The thickness of the outer fluoroplastic sleeve of the fuser member herein is from about 10 microns to about 350 microns, or from about 15 microns to about 100 microns, or from about 20 to 80 microns.

Examples of suitable substrate 110 materials include, in the case of roller substrate, metals such as aluminum, stainless steel, steel, nickel and the like. In embodiments, the substrate material can include polymers such as polyimides, polyamideimides, polyetherimides, polyether ether ketones and polyphenylene sulfides.

When a fluoroplastic sleeve is used to manufacture a fuser roller, there are several methods that can be used. A first method involves obtaining a substrate and positioning a fluoropolymer sleeve around an outer surface of the substrate. An elastomer is injected between the outer surface of the substrate and an inner surface of the sleeve to form a fuser member. The silicone is cured in the mold and then demolded. Optionally, the fuser member is post cured to improve silicone properties. The fuser member is then heated to a temperature of about 30° C. below the melting point of said fluoropolymer sleeve to about 50° C. above the melting point of said fluorpolymer sleeve. In embodiments, the fuser member is heated to a temperature of about 20° C. below the melting point of said fluoropolymer sleeve to about 30° C. above the melting point of said fluorpolymer sleeve, or heated to a temperature of about 10° C. below the melting point of said fluoropolymer sleeve to about 20° C. above the melting point of said fluoropolymer sleeve.

A second method involves positioning a fluoroplastic sleeve around a substrate having an elastomeric layer thereon. The sleeve and substrate are heated to a temperature above the melting point of the fluoroplastic causing the sleeve to shrink and thereby form a fuser member. In embodiments, a primer layer is included over the elastomer.

In the methods of manufacturing fuser members described above, the inner surface of the fluoropolymer sleeve can be etched to increase adhesion. In addition, the outer surface of the substrate can be roughened to increase adhesion with the elastomer and/or primer layers.

A problem with manufacturing fuser rollers is that silicone is degraded at high temperatures, above about 260° C., while the fluoroplastic sleeves develop improved properties when baked in the 320° C. to 400° C. range. There is a delicate balance between under-curing the TEFLON®-like material which can result in poor wearing components or overheating the silicone and damaging it. The latter condition will cause it to take a set easily when in contact with the pressure roll, stripper fingers or other components causing a quality defect such as crinkle.

In order to provide improved properties to a fuser roller formed by the methods described above, the fuser roll is conditioned by heating to a temperature of between about 30° C. below the melting point of the fluoropolymer sleeve and about 50° C. above the melting point of the fluoropolymer sleeve. In embodiments, the temperature range may be from about 20° C. below the melting point of the fluoropolymer sleeve and about 30° C. above the melting point of the fluoropolymer sleeve, or from about 10° C. below the melting point of the fluoropolymer sleeve to about 20° C. above the melting point of the fluoropolymer sleeve. The period of time for this initial heating is from about 1 to about 20 minutes, or from about 1 minute to about 10 minutes or from about 1 to about 5 minutes. After this initial heating, the fuser member may be additionally treated as described in US Pub. 2009/0022897 to improve the physical properties of the silicone. The additional treatment involves heating the fuser member to a temperature of about 175° C. to about 275° C., or from about 220° C. to about 260° C. or from about 230° C. to about 240° C. and held at that temperature for a period of about 4 hours to about 20 hours. In embodiments, the period of time for the second temperature heating is from about 4 hours to about 15 hours, or from about 10 hours to about 12 hours.

Examples of conductive particles or fillers that can be included in the fluoropolymer sleeve or the elastomer layer include carbon nanotubes (CNT), carbon blacks such as carbon black, graphite, acetylene black, graphite, grapheme, fluorinated carbon black, and the like, metal, metal oxides and doped metal oxides, such as tin oxide, antimony dioxide, antimony-doped tin oxide, titanium dioxide, indium oxide, zinc oxide, indium oxide, indium-doped tin trioxide, silicon carbide, metal carbide and the like, and mixtures thereof. The conductive particles may be present in an amount of from about 0.1 weight percent to about 30 weight percent and or from about 0.5 weight percent to about 20 weight percent, or from about 1 weight percent to about 10 weight percent of total solids of either the fluoropolymer sleeve. The intermediate layer typically has from about 20 volume percent to about 50 volume percent of conductive particles or fillers

Optionally, any known and available suitable adhesive or primer layer may be positioned between the elastomer layer, the fluoropolymer sleeve and the substrate. Examples of suitable adhesives include silanes such as amino silanes (such as, for example, HV Primer 10 from Dow Corning), titanates, zirconates, aluminates, and the like, and mixtures thereof. In an embodiment, an adhesive in from about 0.001 percent to about 10 percent solution can be applied to the substrate. The adhesive layer can be coated on the substrate, or on the outer layer, to a thickness of from about 2 nanometers to about 2,000 nanometers, or from about 2 nanometers to about 500 nanometers for a silane adhesive. Commercially available adhesives can have the above agents in an elastomer rich solution. When this occurs the thickness of the adhesive layer is from about 2 microns to about 10 microns, or from about 2 microns to about 5 microns. The adhesive can be coated by any suitable known technique, including spray coating or wiping.

The Young's Modulus of the fluoropolymer sleeve is from about 50 kpsi to about 100 kpsi, or from about 70 kpsi to about 95 kpsi, or from about 85 kpsi to about 95 kpsi. The tensile stress in the outer layer is from about 1000 psi to about 5000 psi, or from about 2000 psi to about 4000 psi, or from about 2700 psi to about 3300 psi. This fuser member described herein exhibits as surface conductivity of less than about 10⁹Ω/square. However, there are applications where non-electrically conductive sleeves are used and the surface conductive is greater than about 10¹⁴Ω/square.

### EXAMPLES

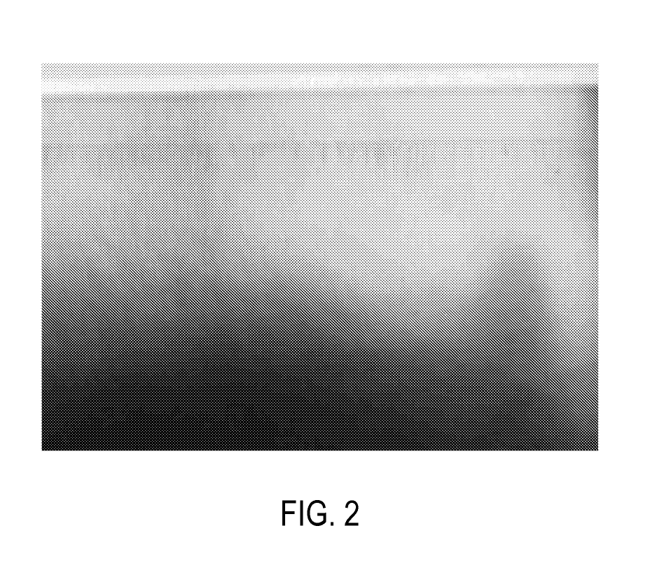

A perfluoroalkoxy polymer resin (PFA) sleeve was molded in place with silicone, cured, demolded and post cured at 200° C. for four hours. The thickness of the fluoropolymer sleeve was about 30 microns and the intermediate silicone layer was about 570 microns in thickness. The substrate was an aluminum tube having thickness of about 3 mm. The fuser roller was installed in an Olympia Docucolor 250 machine and 300,000 images were run through the machine. FIG. 2 shows a picture of the fuser roller after this test. There are noticeable crinkles along the edge of the fuser roll. These crinkles lead to defective substrate images and customer dissatisfaction. Typically fuser rollers are replaced when the crinkle defect appears.

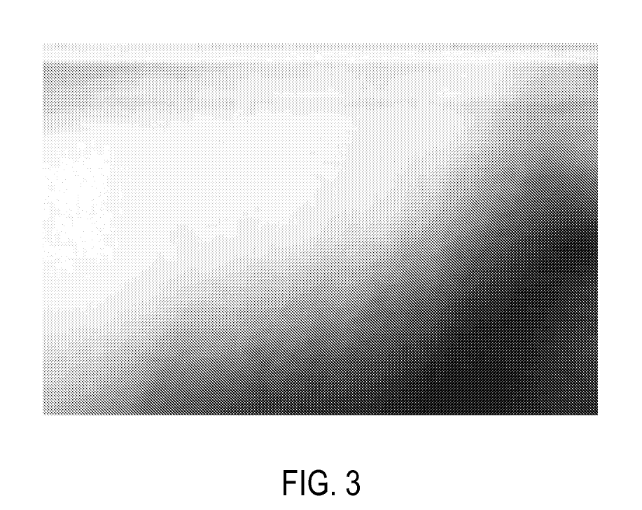

A second fuser roller as described above was heated to 300° C. for 20 minutes and then heated at 240° C. for 11 hours. The resulting fuser roller was installed in an Olympia Docucolor 250 machine and 300,000 images were run through the machine. FIG. 3 shows a picture of the fuser roller after this test. There are no crinkles in the fuser roller. The images produced by this roller are acceptable to a customer. Thus, the treatment described provides a fuser roller that lasts longer than an untreated fuser roller.

Other embodiments of the present teachings will be apparent to those skilled in the art from consideration of the specification and practice of the present teachings disclosed herein. It is intended that the specification and examples be considered as exemplary only, with a true scope and spirit of the present teachings being indicated by the following claims.

What is claimed is:

1. A method for the production of a fuser member comprising:
obtaining a substrate;
positioning a fluoropolymer sleeve around an outer surface of the substrate;
injecting an elastomer between the outer surface of the substrate and an inner surface of the sleeve to form a fuser member;
curing the fuser member;
conditioning the fuser member at a first temperature of between about 30° C. below a melting point of said fluoropolymer sleeve and about 50° C. above the melting point of said fluoropolymer sleeve for about 1 to about 20 minutes.

2. The method of claim 1, further comprising, heating the fuser member to a second temperature of about 220° C. to about 260° C. for a period of about 4 hours to about 20 hours.

3. The method of claim 1 wherein said fluoropolymer sleeve is selected from the group consisting of polytetrafluoroethylene, perfluoroalkoxy polymer resin, copolymers of tetrafluoroethylene and hexafluoropropylene; copolymers of hexafluoropropylene and vinylidene fluoride and copolymers of tetrafluoroethylene, vinylidene fluoride, and hexafluoropropylene.

4. The method of claim 1 wherein the elastomer is selected from the group consisting of silicone rubbers, high temperature vulcanization silicone rubbers, low temperature vulcanization silicone rubbers, liquid silicone rubbers and siloxanes.

5. The method of claim 1 wherein the fluoropolymer sleeve further comprises conductive fillers.

6. The method of claim 5 wherein the conductive fillers are selected from the group consisting of carbon nanotubes, carbon black, acetylene black, graphite, graphene, metal, metal oxide, doped metal oxides, silicon carbide and metal carbide.

7. The method of claim 1 wherein the substrate is selected from the group consisting of aluminum, stainless steel, steel, nickel, polyimide, polyamideimide, polyetherimide, polyether ether ketone and polyphenylene sulfide.

8. The method of claim 1 wherein the inner surface of the sleeve has been etched.

9. The method of claim 1 wherein the outer surface of the substrate has been roughened.

10. The method of claim 1 further comprising an adhesive layer disposed between the elastomer and the substrate.

11. The method of claim 1 further comprising an adhesive layer disposed between the fluoroploymer sleeve and the elastomer.

12. A method for the production of a fuser member comprising:
obtaining a substrate having disposed thereon an elastomer;
positioning a fluoropolymer sleeve over the substrate and heat shrinking the sleeve to form a fuser member; and
conditioning the fuser member at a first temperature of between about 30° C. below a melting point of said fluoropolymer sleeve and about 50° C. above the melting point of said fluoropolymer sleeve for about 1 to about 20 minutes.

13. The method of claim 12 further comprising heating the fuser member to a second temperature of about 220° C. to about 260° C. for a period of about 4 hours to about 20 hours.

14. The method of claim 12 wherein said fluoropolymer sleeve is selected from the group consisting of polytetrafluoroethylene (PTFE), fluorinated ethylene propylene (FEP), perfluoroalkoxy (PFA), polychlorotrifluoroethylene (ECTFE), ethylene-chlorotrifluoroethylene (ECTFE), ethylene-chlorotrifluoroethylene (ECTFE), ethylene-tetrafluoroethylene (ETFE), polyvinylidene fluoride (PVDF) and polyvinyl fluoride (PVF).

15. The method of claim 12 wherein the elastomer is a silicone material.

16. The method of claim 12 wherein the substrate is selected from the group consisting of aluminum, stainless steel, steel, nickel, polyimide, polyamideimide, polyetherimide, polyether ether ketone and polyphenylene sulfide.

17. The method of claim 12 further comprising a primer layer disposed between the elastomer and the substrate.

18. The method of claim 12 further comprising a primer layer disposed between the fluoroploymer sleeve and the elastomer.

19. A method for reconditioning a fuser member comprising:
obtaining a fuser member having a substrate and elastomeric layer disposed on the substrate and a fluoroplastic sleeve disposed on the elastomeric layer;
conditioning the fuser member at a first temperature of between about 30° C. below a melting point of said fluoropolymer sleeve and about 50° C. above the melting point of said fluoropolymer sleeve for about 1 to about 20 minutes; and
heating the fuser member to a second temperature of about 220° C. to about 260° C. for a period of about 4 hours to about 20 hours.

20. The method of claim 19 wherein the fuser member further comprises a primer layer disposed between the fluoroploymer sleeve and the elastomeric layer.
